(19) United States
(12) Patent Application Publication
(10) Pub. No.: US 2005/0120148 A1
(43) Pub. Date: Jun. 2, 2005

(54) Storage medium storing preloading data, and apparatus and method for reproducing information from storage medium

(75) Inventors: Kil-soo Jung, Hwaseong-si (KR); Sung-wook Park, Seoul (KR); Man-seok Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECGRONICS CO., LTD, Suwon-si (KR)

(21) Appl. No.: 10/992,106

(22) Filed: Nov. 19, 2004

(30) Foreign Application Priority Data
Nov. 19, 2003 (KR) 2003-82338

(51) Int. Cl. G06F 13/28; G06F 3/00

(52) U.S. Cl. 710/29; 710/33; 710/56; 710/58; 710/52; 710/20

(57) ABSTRACT

A storage medium including image data, program data to control an interaction with a user during reproduction of the image data, and loading information to cause the image data to be seamlessly reproduced during reproduction of the program data, and an apparatus to reproduce, and a method of reproducing, the data from the storage medium.

### CROSS-REFERENCE TO RELATED APPLICATIONS

This application claims the priority of Korean Patent Application No. 2003-82338, filed on Nov. 19, 2003, in the Korean Intellectual Property Office, the disclosure of which is incorporated herein in its entirety by reference.

### BACKGROUND OF THE INVENTION

1. Field of the Invention

The present invention relates to reproduction of information from a storage medium, and, more particularly, to a storage medium storing preloading data that allows seamless reproduction of video object data, and an apparatus and method for reproducing information from the storage medium.

2. Description of the Related Art

Audio-Visual (AV) data that contains video, audio, or subtitles that are compression-encoded according to the Motion Picture Experts Group (MPEG) standards is recorded on a storage medium such as a Digital Versatile Disc (DVD). In this disclosure, the AV data including still image data will be referred to as video object data.

Additional information such as information regarding an entry point for encoding or random access for video object data, and a PlayList regarding a sequence of reproducing the video object data may further be recorded on the storage medium such as a DVD.

Navigation information includes navigation commands that instruct PlayLists to be reproduced or linked to other PlayLists so as to control reproduction of the video object data. In general, the navigation information is stored as a table consisting of binary code. Thus, the navigation information allows information regarding the video object data to be reproduced based on the navigation information, and also allows a user to view a moving image such as a high-quality movie. A set of the navigation commands is referred to as a movie object.

However, it is difficult to record, on a conventional storage medium, information regarding video object data together with a program such as a moving image game and a video chatting program that provides an interaction with a user. In other words, it is difficult to reproduce the information regarding video object data together with a program that provides an interaction with a user.

A conventional storage medium can support seamless reproduction of video object data. In general, since information for seamless reproduction of video object data is multiplexed and included in the video object data, it is possible to seamlessly reproduce the video object data without additionally processing it. However, the video object data must be additionally processed for seamless reproduction thereof when it is reproduced together with a program that provides an interaction with a user.

### SUMMARY OF THE INVENTION

The present invention provides a storage medium that stores preloading information that causes seamless reproduction of video object data.

The present invention also provides an apparatus and method for executing a program that provides an interaction with a user while seamlessly reproducing video object data using preloading information.

Additional aspects and/or advantages of the invention will be set forth in part in the description which follows and, in part, will be obvious from the description, or may be learned by practice of the invention.

According to one aspect of the present invention, there is provided a storage medium comprising image data, program data to control an interaction with a user during reproduction of the image data, and loading information to cause the image data to be seamlessly reproduced during reproduction of the program data.

The loading information may include location information of the program data to be preloaded prior to the reproduction of the program data. The storage medium may further include confirmation information regarding a current loading state of the program data based on the loading information.

The confirmation information may be included in the program data.

The confirmation information may comprise an attribute indicating whether the loading of the program data based on the loading information is completed. A value of the attribute may be set to a first value in response to the loading of the program data based on the loading information being completed, and otherwise be set to a second value.

The confirmation information may comprise an event generated in response to the loading of the program data based on the loading information being completed.

The confirmation information may comprise a command that confirms a current loading state of the program data. Return values of the command may be determined as three types that indicate that the loading is completed, the loading continues, and the loading has failed, respectively.

The confirmation information may comprise a loading package including an application program interface to cause the confirmation information to be available in the program data.

The storage medium may be detachable from a reproducing apparatus, and may be an optical disc from which data can be read using an optical device of a reproducing apparatus.

According to another aspect of the present invention, there is provided a reproducing apparatus to reproduce information from a storage medium storing image data, program data providing an interaction with a user during reproduction of the image data, and loading information to cause seamless reproduction of the image data during reproduction of the program data, the reproducing apparatus comprising a buffer manager; and application manager to read the loading information, detect a location of the program data to be preloaded prior to the reproduction of the program data, and send the buffer manager information regarding the location of the program data; and a program engine to receive information regarding a current loading state from the buffer manager and reproduce the preloaded program data; wherein the buffer manager controls the program data to be preloaded based on the information regarding the location of the program data.

The reproducing apparatus may further include a reading unit to read various data from the storage medium; a buffer unit to classify and temporarily store the read data into types; a reproducing unit to classify and reproduce the temporarily stored data according to the types; and a blender to blend and display the reproduced data on a screen.

The storage medium may comprise confirmation information to confirm whether a loading state of the program data is completed, wherein the buffer manager loads the program data to the buffer unit based on the information regarding the location of the program data, sets the confirmation information in response to the loading being completed, and sends the confirmation information to the program engine.

The confirmation information may comprise an attribute indicating whether the loading of the program data is completed, wherein the buffer manager may set a value of the attribute as a first value in response to the loading being completed, and otherwise sets a value of the attribute as a second value.

The confirmation information may comprise an event generated in response to the loading of the program data being completed, wherein the program engine and/or the application manager may execute a program according to the event, or controls the program data to be reproduced.

The confirmation information may comprise a command regarding a current loading state, wherein the buffer manager may send one of a plurality of return values of the command that respectively indicate that the loading is completed, the loading continues, and the loading has failed.

The program engine may parse the confirmation information from the program data, send a result of the parsing to the buffer manager, receive a sent return value, and execute a program based on the returned information.

According to yet another aspect of the present invention, there is provided a method of reproducing data, the method comprising loading program data based on loading information to reproduce the program data from a storage medium that stores image data, the program data providing an interaction with a user during reproduction of the image data, and the loading information causing seamless reproduction of the image data during reproduction of the program data; setting confirmation information regarding a current loading state of the program data to indicate that the loading is completed in response to the loading being completed; and reproducing the loaded program data when the confirmation information indicates that the loading is completed.

According to still another aspect of the present invention, there is provided a method of reproducing data from a storage medium comprising image data and program data, the method comprising preloading the program data based on preloading information before beginning to reproduce the program data, using both the preloading information and postloading information, from the storage medium, wherein the program data provides an interaction with a user during reproduction of the image data and causes seamless reproduction of the image data during reproduction of the program data, the preloading information and the postloading information being included in the program data; setting confirmation information to indicate that the preloading of the program data is completed in response to the preloading being completed; and reproducing the preloaded program data in response to the confirmation information indicating that the preloading is completed.

The reproducing of the preloaded program data may comprise postloading a required program based on the postloading information, and setting confirmation information to indicate that the postloading is completed in response to the postloading being completed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates various types of data stored in a storage medium according to an embodiment of the present invention;

FIG. 2 is a schematic block diagram of a reproducing apparatus according to an embodiment of the present invention;

FIG. 3 is a detailed block diagram of a reproducing apparatus according to an embodiment of the present invention;

FIG. 4 is a diagram illustrating a mechanism of a reproducing apparatus that processes preloading information according to an embodiment of the present invention;

FIG. 5 illustrates a definition of an Application Program Interface (API) between a buffer manager and a program engine of FIG. 4 using an Interface Definition Language according to an embodiment of the present invention;

FIG. 6 illustrates a definition of the API between the buffer manager and the program engine of FIG. 4 using JAVA according to an embodiment of the present invention;

FIG. 7 is a flowchart of a method of reproducing information from a storage medium that stores preloading information according to an embodiment of the present invention;

FIG. 8 is a flowchart of a method of reproducing information from a storage medium that stores both preloading information and postloading information according to an embodiment of the present invention;

FIG. 9 is a flowchart of a method of reproducing information from a storage medium that stores preloading information according to another embodiment of the present invention; and

FIG. 10 is a flowchart of a method of reproducing information from a storage medium that stores both the preloading information and postloading information according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A storage medium according to an embodiment of the present invention stores program data that provides an interaction with a user, and preloading information that allows the program data to be loaded to a buffer before reproduction of video object data so as to seamlessly reproduce the video object data even when reproducing the program data. The storage medium also stores confirmation information regarding a current loading state of the buffer.

The preloading information contains information regarding the location of the program data so as to store the program data in the buffer. The preloading information may be described using binary values or text. The confirmation information may be realized as an attribute, an event, or a method.

Structures of data stored in a storage medium according to an embodiment of the present invention will now be described.

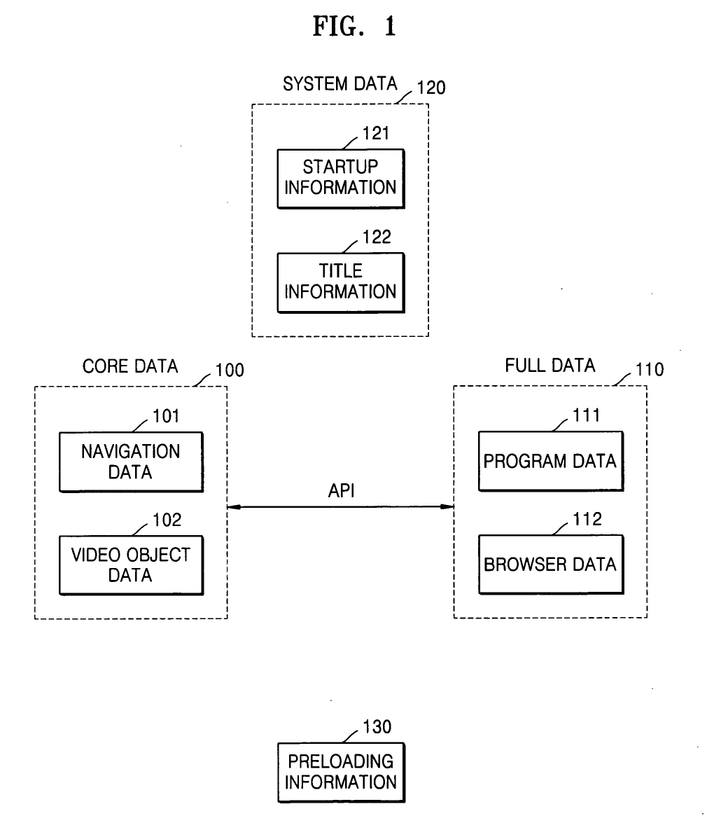

FIG. 1 illustrates various types of data stored in a storage medium according to an embodiment of the present invention. Referring to FIG. 1, core data 100, full data 110, system data 120, and preloading information 130 are recorded on the storage medium according to the embodiment of the present invention.

The core data 100 is used for reproduction of a moving image. The core data 100 contains video object data 102 that is compression-encoded and navigation information 101 that controls reproduction of the video object data 102. The video object data 102 includes record units such as a clip A/V stream file encoded according to the MPEG standard, and a clip information file containing the attributes of the encoded clip A/V stream file and entry point information. Also, the video object data 102 contains reproduction units such as a PlayItem that specifies the in-time and out-time locations of the clip information file, and a PlayList consisting of a plurality of PlayItems.

The navigation information 101 allows reproduction of the video object data 102 so that a user may view a moving image such as a high-resolution movie. A mode where the core data 100 is reproduced will be hereinafter referred to as a core mode or a movie mode.

The full data 110 specifies additional functions other than reproduction of the video object data 102. The full data 110 includes program data 111 that provides an interaction with the user, and/or browser data 112 that is used to reproduce information regarding a moving image from a markup document. When the additional functions are not required, the full data 110 may not be stored in the storage medium.

The program data 111 allows use of a moving image game, director's commentary to be downloaded via a network and displayed while reproducing parts of a moving image, additional information to be displayed while reproducing parts of a moving image, or chatting while reproducing a moving image. The program data 111 may contain a program described in JAVA. A mode in which the program data 111 is reproduced will be hereinafter referred to as a program mode.

The browser data 112 includes commands that cause information regarding a moving image to be obtained and reproduced from a markup document. The commands may be described in a markup language, such as a HyperText Markup Language (HTML) and an extended Markup Language (XML), and/or a script language such as an ECMA Script. It is possible to obtain the information regarding the moving image from the markup document and reproduce it together with the moving image, using the browser data 112. For instance, it is possible to reproduce movie data from a storage medium together with recent information regarding actors, information regarding an event, or information regarding updated subtitles regarding the movie data, stored in a web page or a file. A mode in which the browser data 12 is reproduced will be hereinafter referred to as a browser mode. The full data 110 may further include other data regarding additional functions.

The system data 120 controls reproduction of the core data 100 and/or the full data 110, and includes startup information (or first playback information) 121 and title information 122. The startup information 121 indicates the location of an object that will be first reproduced from the storage medium. The title information 122 includes information regarding entry points regarding the locations of the other objects.

For seamless reproduction of the video object data in the program mode, the preloading information 130 designates the program data 111 that is to be preloaded to a data buffer for the program mode which will be later described in detail. The preloading information 130 may be represented as binary values and/or text.

As shown in FIG. 1, the program data 111 is recorded separately from the core data 100 regarding reproduction of the video object data 102. Thus, in the program mode where the program data 111 is reproduced to provide an interaction with the user during reproduction of the video object data 102, frequent movement of a pickup in order to read the core data 100 and the program data 111 from different parts of the storage medium is unavoidable. In this case, reproduction of the video object data 102 may be discontinued temporarily. To solve this problem, the program data 111 must be partially or entirely buffered. It is possible to designate the program data 111 that is to be buffered, using the preloading information 130.

In other words, when the video object data 102 is reproduced in the program mode, the program data 111 and various resources on which the program is based are preloaded to the program buffer using the preloading information 130 for seamless reproduction of the video object data 102.

The preloading information 130 is also available in the browser mode for seamless reproduction of the video object data 102. However, in this disclosure, the preloading information 130 will be described with respect to the program mode for convenience.

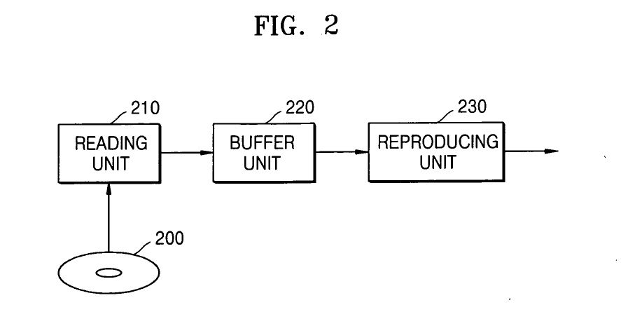

FIG. 2 is a schematic diagram of a reproducing apparatus according to an embodiment of the present invention. The reproducing apparatus of FIG. 2 includes a reading unit 210, a buffer unit 220, and a reproducing unit 230.

The reading unit 210 reads information that will be reproduced from a storage medium 200. If the storage medium 200 is an optical disc, the reproducing apparatus further includes an optical device that reads data from the optical disc. The buffer unit 220 temporarily stores the data read by the reading unit 210. The reproducing unit 230 reproduces the core data 100 and the full data 110 of FIG. 1 that are temporarily stored, using a reproduction engine (not shown) that best suits a reproduction mode such as a core mode, a program mode, or a browser mode. The core data 100 and the full data 110 are reproduced by the reproduction engine and displayed on a display device (not shown).

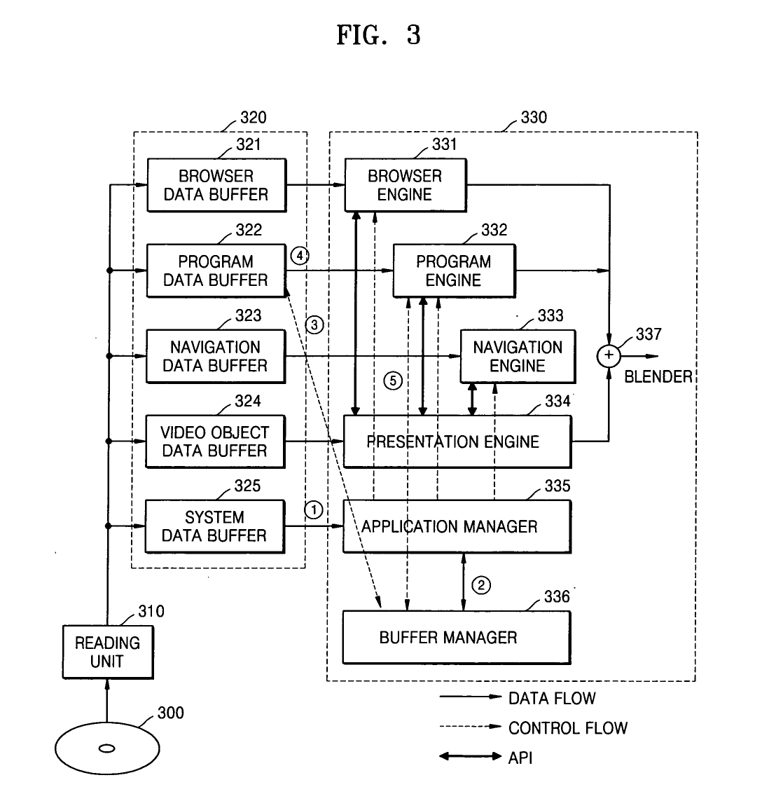

FIG. 3 is a detailed block diagram of a reproducing apparatus according to an embodiment of the present invention. The reproducing apparatus of FIG. 3 includes a reading unit 310, a buffer unit 320, and a reproducing unit 330.

The reading unit 310 reads the browser data 112, the program data 111, the navigation information 101, the video object data 102, the system data 120, and the preloading information 130 of FIG. 1 from a storage medium 300, and temporarily buffers them in the buffer unit 320.

The buffer unit 320 includes a browser data buffer 321, a program data buffer 322, a navigation data buffer 323, a video object data buffer 324, and/or a system data buffer 325 that are categorized according to types of data to be stored.

Specifically, the read browser data 112 is buffered by the browser data buffer 321, the program data 111 is buffered by the program data buffer 322, the navigation information 101 is buffered by the navigation data buffer 323, the video object data 102 is buffered by the video object data buffer 324, and the system data 120 and the preloading information 130 are buffered by the system data buffer 325.

The reproducing unit 330 includes a browser engine 331, a program engine 332, a navigation engine 333, a presentation engine 334, and an application manager 335 that are categorized according to types of data to be reproduced, a buffer manager 336, and a blender 337.

The browser engine 331 receives the browser data 112 from the browser data buffer 321 and reproduces information regarding a moving image from a markup document using the browser data 112. That is, the browser engine 331 executes a browsing command implemented in a markup language or a script language, included in the browser data 112. Execution of the browsing command allows the information regarding the video object data 102 to be obtained and reproduced from the markup document. The browser engine 331 is capable of controlling the presentation engine 334 via an Application Program Interface (API).

The program engine 332 receives the program data 111 from the program data buffer 322 and provides an interaction with a user. For instance, the program engine 332 executes a particular program that enables a game, chatting, and displaying directors commentary. The program engine 332 can provide an interaction with the user using a moving image. The program engine 332 controls the presentation engine 334 via the API and can control the buffer manager 336 to check a preloading state of the program data buffer 322.

The navigation engine 333 receives the navigation information 101 from the navigation data buffer 323 and controls reproduction of the video object data 102 based on the navigation information 101. The navigation engine 333 can control the presentation engine 334 via the API.

That is, the browser engine 331, the program engine 332, and the navigation engine 333 can control the presentation engine 334 to reproduce the video object data 102 and/or provide additional functions via the API.

The presentation engine 334 receives the video object data 102 that is compression-decoded from the video object data buffer 324 and decodes and reproduces the video object data 102. The video object data 102 may include a video stream, a still image stream, or a data file.

The application manager 335 receives the system data 120 from the system data buffer 325 and controls the browser engine 331, the program engine 332, the navigation engine 333, and the presentation engine 334 based on the system data 120. Specifically, the application manager 335 detects and reproduces an object that should be first reproduced from the storage medium 300 using the startup information 121 of the system data 120. Also, the application manager 335 determines the type of the object and activates one of the browser engine 331, the program engine 332, the navigation engine 333, and the presentation engine 334 that matches the type of object. In this case, mode information contained in the title information 122 of the system data 120 may be available. Further, the application manager 335 detects the location of an object that is to be reproduced using entry point information included in the title information 122 and reproduces the object using the activated engine.

The application manager 335 includes a user interface (not shown) for processing user input and sends it to one of the browser engine 331, the program engine 332, the navigation engine 333, and the presentation engine 334 that is selected according to a current mode.

The application manager 335 receives the preloading information 130 from the system data buffer 325, as indicated by an arrow \mathring{1}, and reads the mode information included in the system data 120 to determine whether data that is to be reproduced is the program data 111, and sends the preloading information 130 to the buffer manager 336 when the data is the program data 111, as indicated by an arrow \mathring{2}.

The buffer manager 336 controls the program data 111 containing required resource files to be preloaded to the program data buffer 322 prior to reproduction of the program data 111, based on the preloading information 130, as indicated by an arrow \mathring{3}. After the preloading of the program data 111, the program data buffer 322 sends the program data 111 to the program engine 332 so that the program engine 332 can start reproduction of the program data 111 in the program mode, as indicated by an arrow \mathring{4}. In this case, the program engine 332 sends confirmation information to the buffer manager 336 so as to check whether the preloading of the program data 111 is completed, receives a turnaround information regarding the confirmation information or a confirmation message generated by the buffer manager 336 from the buffer manager 336, and determines the state of the program data buffer 322, as indicated by an arrow \mathring{5}. If the returned information or the confirmation message reads that the preloading is completed, the program engine 332 starts the reproduction of the program data 111. If the preloading of the program data 111 to the program data buffer 322 fails, a replacement for the program data 111 or an error message may be displayed. Accordingly, even if the preloading fails, it is possible to treat an error caused by the failure in the preloading. If the preloading of the program data 111 continues, the buffer manager 336 can control the program engine 332 to delay reproduction until the preloading is completed.

The blender 337 blends graphics reproduced by the browser engine 331, the program engine 332, and/or the presentation engine 334 to make an image, and outputs the image. Accordingly, the reproducing apparatus of FIG. 3 performs additional functions such as browsing or execution of a program while reproducing the video object data 102.

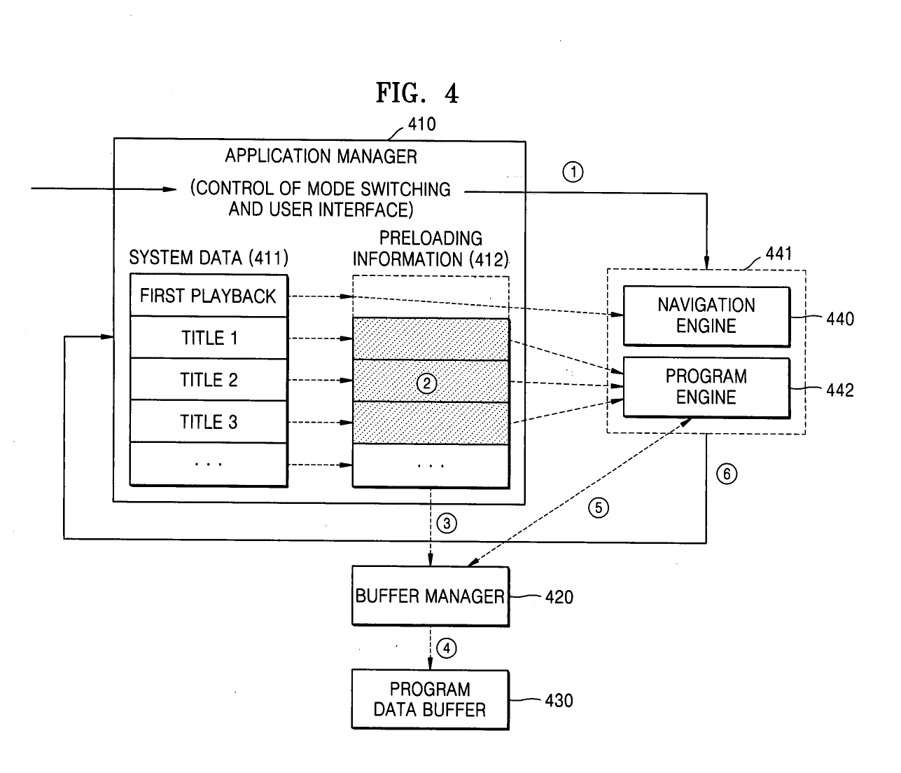

FIG. 4 illustrates the mechanism of a reproducing apparatus that processes preloading information according to an embodiment of the present invention. Referring to FIG. 4, an application manager 410 receives system data 411 and preloading information 412 from the system data buffer 325 of FIG. 3. When a storage medium (not shown) is loaded into a disc drive (not shown), the system data 411 is transmitted to the application manager 410, a first mode in which data is reproduced and first data that is to be reproduced are determined based on startup information (or first playback information) (not shown) of the system data 410 of FIG. 1. The first mode may be specified in mode information of the system data 411 or determined according to the type of data that is to be reproduced. The type of data is determined by detecting the address of data that is to be reproduced and reading the data at the address.

In particular, FIG. 4 illustrates a general movie mode, i.e., a core mode, as the first mode. In the core mode, a navigation engine 440 operates as specified in the mode information or data described at the detected address, and reproduces a movie object that is to be first reproduced based on entry point information included in the startup information. In general, reproduction of data in the core mode is similar to that of DVD-video, and seamless reproduction of video object data is guaranteed in the core mode without preloading information.

Titles 1, 2, and 3 included in the system data 411 must be reproduced in the program mode. In general, in the program mode, a moving image is reproduced together with its additional information so as to provide a user with the additional information during reproduction of the moving image. The additional information may include various resources such as a program application, audio, and an image. A reading unit (not shown) repeatedly moves to read the video object data 102 and the program data 111 of FIG. 1 that includes various resources from the storage medium. In this case, reproduction of the video object data 102 that needs to be decoded and reproduced is likely to fail, and thus it is impossible to guarantee seamless reproduction thereof. Thus, in the program mode, the preloading information 412 is preferably preloaded to a program data buffer 430 for seamless reproduction of the video object data 102 in the program mode.

When the storage medium is loaded into the disc drive, the preloading information 412 is read together with the system data 411 and managed by the application manager 410.

The mechanism of the reproducing apparatus using the preloading information 412 will now be described with reference to FIG. 4. First, when data indicated by an entry point of a title specified in the system data 411 must be reproduced in the program mode, a current mode is switched to the program mode based on the mode information so as to operate a program engine 442, as indicated by an arrow \mathring{1}.

Next, the application manager 410 parses the program data 111 required for reproduction of the titles 1, 2, and 3 in the program mode, based on the preloading information 412 linked to the titles 1, 2, and 3, as indicated by \mathring{2}.

Next, the application manager 410 extracts information regarding the location of the program data 111 from the preloading information 412 and sends it to the buffer manager 420, as indicated by an arrow \mathring{3}.

Next, the buffer manager 420 controls the program data 111 to be preloaded to the program data buffer 430, as indicated by an arrow \mathring{4}.

Next, after completing the preloading of the program data 111 designated by the preloading information 412, the buffer manager 420 sets a value of an allDone attribute as “TRUE” to show that the preloading is completed. The program engine 442 refers to the value of the allDone attribute to determine whether the preloading is completed, as indicated by an arrow \mathring{5}.

When the value of the allDone attribute represents that the preloading is completed, the program engine 442 starts reproduction of the program data 111 indicated with an entry point in the system data 411, as indicated by \mathring{6}.

Alternatively, when the titles 1, 2, and 3 included in the system data 411 are linked to only the preloading information 412, and the preloading information 412 specifies the location of the program data 111 that must be preloaded and the location of the entry point of data that is to be reproduced, the buffer manager 420 provides the application manager 410, rather than the program engine 442 as indicated by the arrow \mathring{5}, with information regarding whether the preloading of the program data 111 to the program data buffer 430 is completed. Then, the application manager 410 sends the information to the program engine 442.

While the program engine 442 reproduces the program data 111, data required for reproduction of the program data 111 may further be loaded to the program data buffer 430 as background processing. The loading of the data required for reproduction of the video object data 102 during reproduction will hereinafter be referred to as postloading.

The buffer manger 420 generates a preload trigger event that informs the program engine 442 of the completing of the preloading of the program data 111 when the preloading is completed, and the program engine 442 starts reproduction of the video object data 102. Then, after starting reproduction of the video object data 102, necessary program data and resources are postloaded to the program data buffer 430, and the value of the allDone attribute is set as “TRUE” after completing of the postloading.

As will be later described, the preload trigger event or the allDone attribute may be embodied as a method. That is, the program engine 442 may send the buffer manager 420 confirmation information regarding a loading state that includes commands such as a currentLoadState( ) command, as indicated by the arrow \mathring{5}, so that the buffer manager can determine whether the postloading is completed.

An API between the buffer manager 420 and the program engine 442, to make loading state information available in executing a program, will now be described in detail.

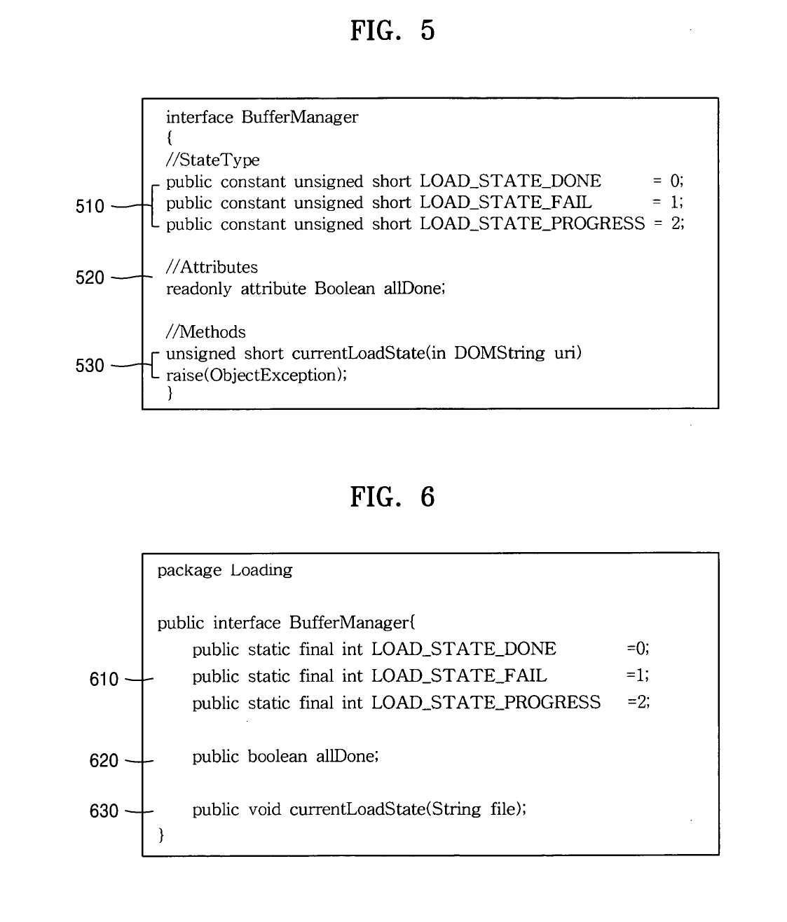

FIG. 5 illustrates a definition of the API with the buffer manager 420 and the program engine 442 of FIG. 4 using an Interface Definition Language (IDL) according to an embodiment of the present invention. The definition of FIG. 5 specifies confirmation information regarding loading state information regarding whether loading of information to a buffer is completed. Referring to FIG. 5, there are three types of constants 510 regarding loading state, i.e., LOAD_STATE_DONE indicating that loading of all data selected is completed, LOAD_STATE_FAIL indicating that the loading has failed, and LOAD_STATE_PROGRESS indicating that the loading continues. In the program mode, the buffer manager 420 informs the program engine 442 of the current loading state using a currentLoadState(in DOMString uri) method that is one of confirmation information, for example. The program engine 442 can determine the current loading state based on values of the constants 510.

In FIG. 5, 520 denotes an allDone attribute representing whether preloading (or postloading) is completed or not. 530 denotes the currentLoadState(in DOMString uri) method regarding a current data loading state. The value of the allDone attribute indicates the loading state of the program data buffer 430 as “TRUE” or “FALSE”. That is, the value of the allDone attribute is represented as “TRUE” when loading of all data selected is completed, and is represented as “FALSE” otherwise.

FIG. 6 illustrates a definition of the API between the buffer manager 420 and the program engine 442 using JAVA according to an embodiment of the present invention. In a JAVA program, the loading package defined in FIG. 6 is imported to make predetermined constants, attributes, and method available.

610 denotes three types of constants regarding a current loading state, i.e., LOAD_STATE_DONE indicating that loading of data selected is completed, LOAD_STATE_FAIL indicating that the loading has failed, and LOAD_STATE_PROGRESS indicating that the loading continues.

620 denotes an allDone attribute representing whether preloading (or postloading) is completed. 630 denotes a currentLoadState(String file) method regarding a current data loading state. The value of the allDone attribute is represented as “TRUE” when loading of data to the program data buffer 430 is completed, and represented as “FALSE” otherwise.

In summary, a storage medium according to an embodiment of the present invention stores the preloading information 130 that allows the program data 111 to be preloaded for seamless reproduction of the video object data 102. The program data 111 includes various resources for the seamless reproduction of the video object data 102, and confirmation information regarding whether preloading (or postloading) is completed. Further, for a case where the program data 111 cannot be stored in the program data buffer 430 since the storage medium is physically damaged or a network malfunctions or is disconnected, API information regarding a loading state of the program data buffer 430 is further stored in the storage medium, thereby preventing an error from occurring when displaying the video object data 102 on a screen.

Accordingly, if the program data 111 is used to reproduce the video object data 102 from a storage medium, i.e., when data related to a moving image is output, it is possible to satisfactorily treat an error by using a replacement for the program data 111 or replacement resources or outputting an error message even if an error such as a delay in downloading occurs.

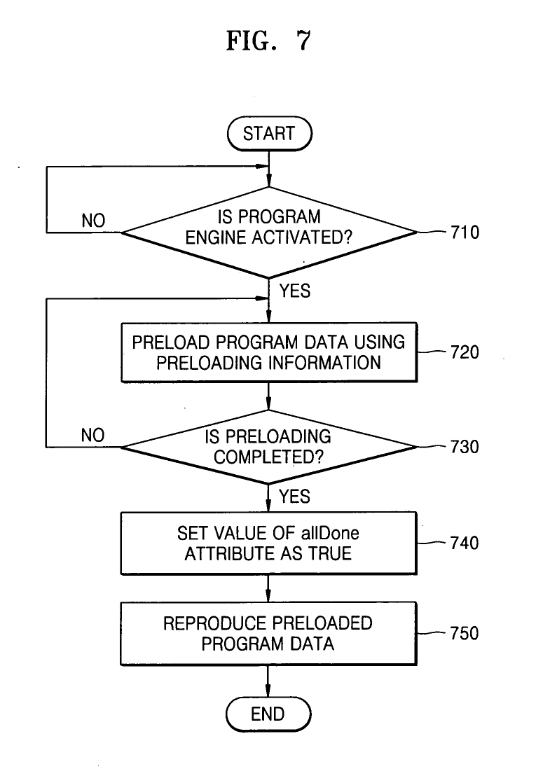

FIG. 7 is a flowchart of a method of reproducing information from a storage medium that stores preloading information according to an embodiment of the present invention. Referring to FIG. 7, for seamless reproduction of video object data 102 in the program mode, the determination of whether the program engine 442 of FIG. 4 is activated is made using mode information (operation 710). Next, program data and information regarding resources required to reproduce a title in the program mode based on the preloading information 412 linked to the title are parsed and preloaded (operation 720). Next, it is determined whether the preloading of the program data and resource information is completed (operation 730). When it is determined in operation 730 that the preloading is completed, the value of the allDone attribute is set as “TRUE” (operation 740). Next, the preloaded program data is reproduced (operation 750).

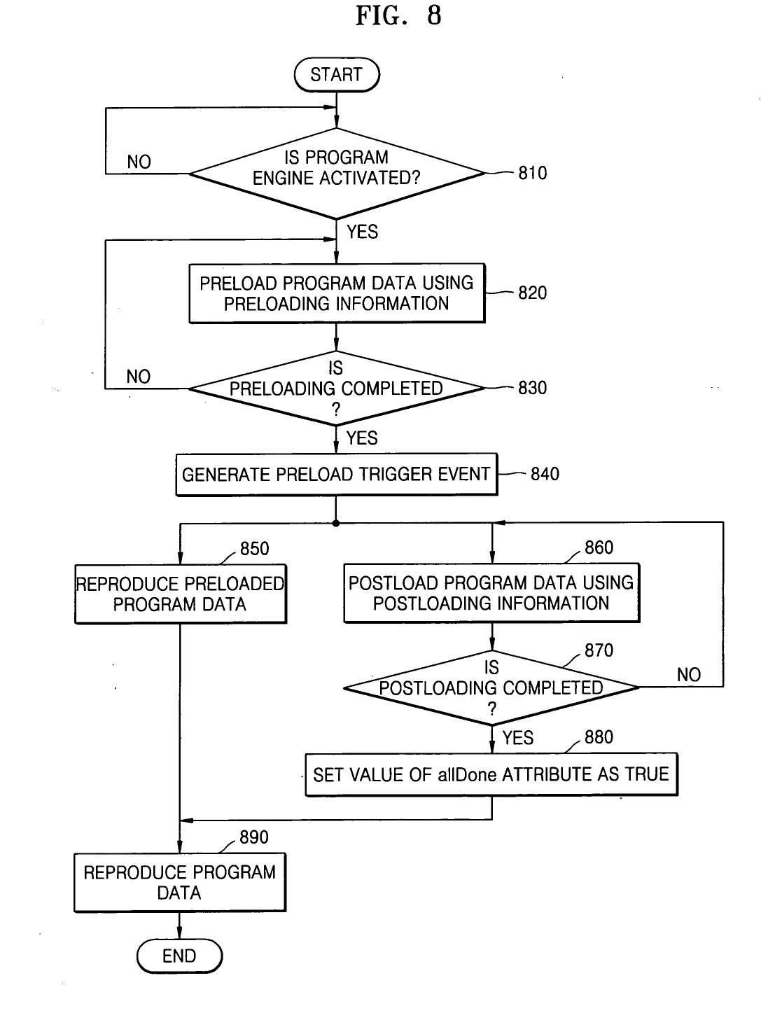

FIG. 8 is a flowchart of a method of reproducing information from a storage medium that stores preloading information and postloading information according to an embodiment of the present invention. In this embodiment, while the program engine 442 reproduces one portion of the program data 111, postloading of another portion of the program data 111 required to reproduce video object data 102 is further performed as background processing, in addition to preloading.

In FIG. 8, since operations 810 through 830 related to preloading are equivalent to operations 710 through 730 of FIG. 7, descriptions of operations 810 through 830 will be omitted. If it is determined in operation 830 that preloading of program data is completed, a preload trigger event is generated (operation 840). Next, while the program data preloaded in operations 810 through 830 is reproduced (operation 850), program data used for a subsequent process is postloaded as background processing using the postloading information (operation 860). Next, whether the postloading is completed is determined (operation 870). If it is determined in operation 870 that the postloading is completed, the value of the allDone attribute is set as “TRUE” to show that the postloading is completed (operation 880). After completing the preloading and the postloading, the program data is reproduced (operation 890).

Alternatively, in the methods of FIGS. 7 and 8, an event or a method other than the attribute value may be used to represent a preloading state or postloading state of a program data buffer.

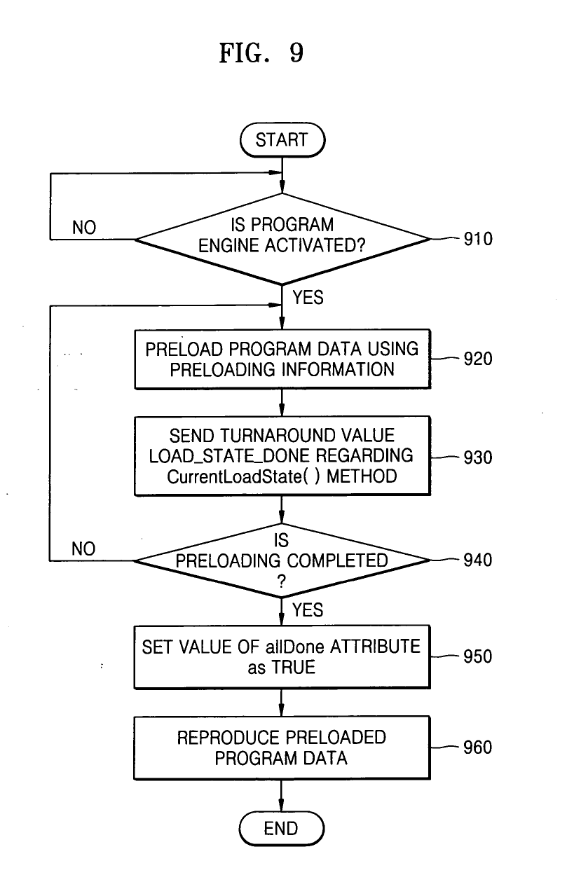

FIG. 9 is a flowchart of a method of reproducing information from a storage medium that stores preloading information according to another embodiment of the present invention. FIG. 9 illustrates that a program engine or an application manager determines a preloading state of a program data buffer using a CurrentLoadState( ) method.

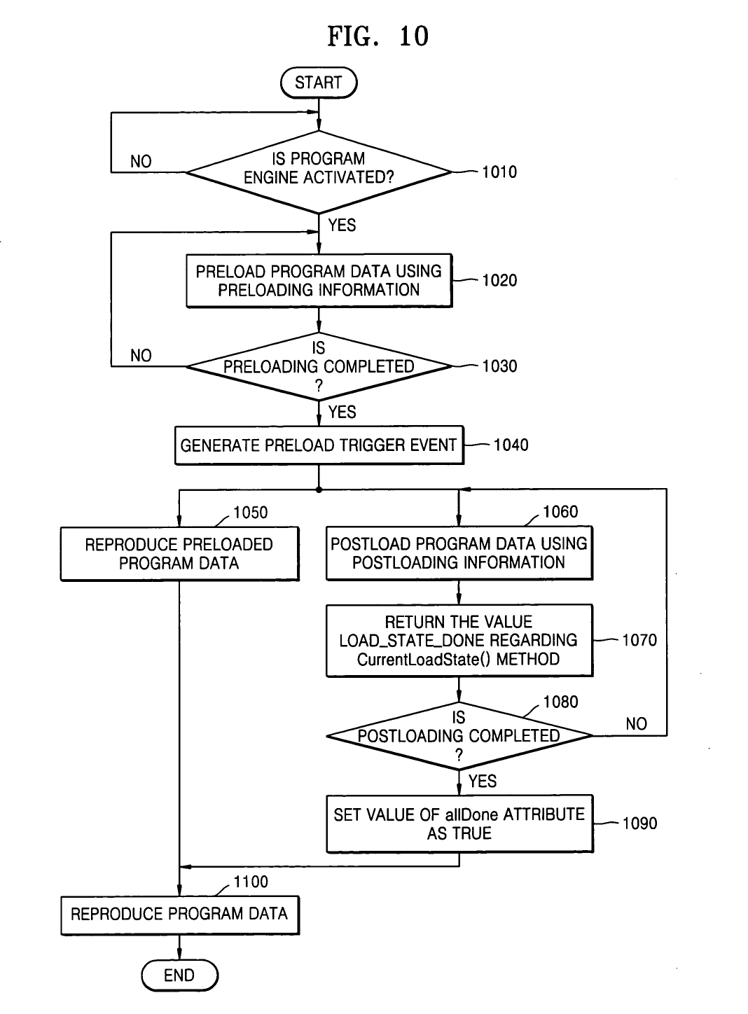

FIG. 10 is a flowchart of a method of reproducing information from a storage medium that stores preloading information and postloading information according to another embodiment of the present invention. In detail, FIG. 10 illustrates that a program engine or an application manager determines a postloading state of a program data buffer using a CurrentLoadState( ) method.

As described above, according to the present invention, for reproduction of video object data in a program mode, program data is preloaded to a buffer using preloading information, confirmation information regarding a current loading state of the buffer is set to represent that the loading of the program data is completed, and the preloaded program data is reproduced based on the confirmation information. Accordingly, it is possible to guarantee seamless reproduction of video object data in a program mode, and further, reproduce program data that provides an interaction with a user.

When program data is reproduced using both preloading information and postloading information, program data is preloaded using the preloading information, confirmation information is set after the preloading to represent that the preloading is completed, reproduction of the preloaded program data begins based on the confirmation information, program data is postloaded as background processing using the postloading information during the reproduction of the preloaded program data, confirmation information is set to represent that the postloading is completed after the postloading, and the postloaded program data is reproduced based on the confirmation information.

Accordingly, it is possible to seamlessly reproduce video object data and reproduce program data that provides an interaction with a user by preloading the program data and postloading further program data as background processing during reproduction of the preloaded program data.

A storage medium according to the present invention is preferably, though not necessarily, an optical disc that can be easily loaded into and removed from a reproducing apparatus, and from which data can be read using an optical device of the reproducing apparatus. The optical disc may be a CD-ROM or a DVD.

The present invention can be embodied as a computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

As described above, the present invention provides a storage medium storing preloading information that guarantees seamless reproduction of video object data, and an apparatus and method for reproducing information from the storage medium. Accordingly, it is possible to execute a program that provides an interaction with a user while seamlessly reproducing the video object data using the preloading information.

Although a few embodiments of the present invention have been shown and described, it would be appreciated by those skilled in the art that changes may be made in these embodiments without departing from the principles and spirit of the invention, the scope of which is defined in the claims and their equivalents.

1. A storage medium comprising:
image data;
program data to control an interaction with a user during reproduction of the image data; and
loading information to cause the image data to be seamlessly reproduced during reproduction of the program data.

2. The storage medium of claim 1, wherein the loading information includes location information of the program data to be preloaded prior to the reproduction of the program data.

3. The storage medium of claim 1, further comprising confirmation information regarding a current loading state of the program data based on the loading information.

4. The storage medium of claim 3, wherein the confirmation information is included in the program data.

5. The storage medium of claim 3, wherein the confirmation information comprises an attribute indicating whether the loading of the program data based on the loading information is completed; and
wherein a value of the attribute is set to a first value in response to the loading of the program data based on the loading information being completed, and is otherwise set to a second value.

6. The storage medium of claim 3, wherein the confirmation information comprises an event generated in response to the loading of the program data based on the loading information being completed.

7. The storage medium of claim 3, wherein the confirmation information comprises a command which confirms a current loading state of the program data; and
wherein return values of the command are determined as three types that indicate that the loading is completed, the loading continues, and the loading has failed, respectively.

8. The storage medium of claim 3, wherein the confirmation information comprises a loading package including an application program interface to cause the confirmation information to be available in the program data.

9. The storage medium of claim 1, wherein the storage medium is detachable from a reproducing apparatus.

10. The storage medium of claim 1, wherein the storage medium is an optical disc from which data can be read using an optical device of a reproducing apparatus.

11. A reproducing apparatus to reproduce information from a storage medium storing image data, program data providing an interaction with a user during reproduction of the image data, and loading information to cause seamless reproduction of the image data during reproduction of the program data, the reproducing apparatus comprising:
a buffer manager;
an application manager to read the loading information, detect a location of the program data to be preloaded prior to the reproduction of the program data, and send the buffer manager information regarding the location of the program data; and
a program engine to receive information regarding a current loading state from the buffer manager and reproduce the preloaded program data;
wherein the buffer manager controls the program data to be preloaded based on the information regarding the location of the program data.

12. The reproducing apparatus of claim 11, further comprising:
a reading unit to read various data from the storage medium;
a buffer unit to classify and temporarily store the read data into types;
a reproducing unit to classify and reproduce the temporarily stored data according to the types; and
a blender to blend and display the reproduced data on a screen.

13. The reproducing apparatus of claim 11, wherein the storage medium comprises confirmation information to confirm whether a loading state of the program data is completed; and
wherein the buffer manager loads the program data to the buffer unit based on the information regarding the location of the program data, sets the confirmation information in response to the loading being completed, and sends the confirmation information to the program engine.

14. The reproducing apparatus of claim 13, wherein the confirmation information comprises an attribute indicating whether the loading of the program data is completed; and
wherein the buffer manager sets a value of the attribute as a first value in response to the loading being completed, and otherwise sets the value of the attribute as a second value.

15. The reproducing apparatus of claim 13, wherein the confirmation information comprises an event generated in response to the loading of the program data being completed; and
wherein the program engine and/or the application manager executes a program according to the event, or controls the program data to be reproduced.

16. The reproducing apparatus of claim 13, wherein the confirmation information comprises a command regarding a current loading state; and
wherein the buffer manager sends one of a plurality of return values of the command that respectively indicate that the loading is completed, the loading continues, and the loading has failed.

17. The reproducing apparatus of claim 13, wherein the program engine parses the confirmation information from the program data, sends a result of the parsing to the buffer manager, receives a sent return value, and executes a program based on the returned information.

18. A method of reproducing data, the method comprising:
loading program data based on loading information to reproduce the program data from a storage medium that stores image data, the program data providing an interaction with a user during reproduction of the image data, and the loading information causing seamless reproduction of the image data during reproduction of the program data;
setting confirmation information regarding a current loading state of the program data to indicate that the loading is completed in response to the loading being completed; and
reproducing the loaded program data when the confirmation information indicates that the loading is completed.

19. A method of reproducing data from a storage medium comprising image data and program data, the method comprising:
preloading the program data based on preloading information before beginning to reproduce the program data, using both the preloading information and postloading information, from the storage medium, wherein the program data provides an interaction with a user during reproduction of the image data and causes seamless reproduction of the image data during reproduction of the program data, the preloading information and the postloading information being included in the program data;
setting confirmation information to indicate that the preloading of the program data is completed in response to the preloading being completed; and
reproducing the preloaded program data in response to the confirmation information indicating that the preloading is completed.

20. The method of claim 19, wherein the reproducing of the preloaded program data comprises:
postloading a required program based on the postloading information; and
setting confirmation information to indicate that the postloading is completed in response to the postloading being completed.

21. A method of reproducing image data from a storage medium, the method comprising:
reproducing program data from the storage medium to provide an interaction with a user; and
using preloading information to control loading of the program data to a buffer before beginning reproduction of the image data so as to seamlessly reproduce the image data.

22. The method of claim 21, further comprising reading confirmation information from the storage medium to determine a current loading state of the program data.

23. The method of claim 21, wherein the program data is recorded on the storage medium separately from the image data.

24. A storage medium comprising:
image data;
program data to control an interaction with a user during reproduction of the image data; and
loading information to control preloading of the program data to a data buffer before execution of the program data.

25. The storage medium of claim 24, further comprising confirmation information regarding a current loading state of the program data based on the loading information.
